(19) United States
(12) Patent Application Publication
(10) Pub. No.: US 2008/0230935 A1
(43) Pub. Date: Sep. 25, 2008

(54) Methods for producing a pitch foam

(76) Inventors: Elliot B. Kennel, Morgantown, WV (US); Alfred H. Stiller, Morgantown, WV (US); Joseph Stoffa, Masontown, PA (US); Mark E. Heavner, Cocoa, FL (US)

Correspondence Address: Dinsmore & Shohl LLP, 255 East Fifth Street, 1900 Chemed Center, Cincinnati, OH, 45202, US

(21) Appl. No.: 11/888,431

(22) Filed: Aug. 1, 2007

Related U.S. Application Data
(60) Provisional application No. 60/834,632, filed on Aug. 1, 2006.

(51) Int. Cl. B29C 67/20

(52) U.S. Cl. 264/29.6; 264/50

(57) ABSTRACT

Methods to produce a pitch foam from a hydrocarbon carbonaceous precursor material. A gaseous blowing material is dissolved in the carbonaceous precursor material, and the resultant solution is pressurized in a vessel. As the solution is exhausted from the vessel, the gaseous blowing agent and the hydrocarbons of the carbonaceous precursor material evaporate from the pressurized solution to form a foam-like solution. The pitch foam is formed from the foam-like solution by directing the foam-like solution onto a surface, whereupon, the foam-like solution solidifies into the pitch foam.

### CROSS REFERENCE TO RELATED APPLICATIONS

This application claims the benefit of U.S. Provisional Patent Application No. 60/834,632, filed Aug. 1, 2006, the entire disclosure of which is considered as part of the disclosure of the present application and is hereby incorporated by reference herein.

### TECHNICAL FIELD

The present invention relates to pitch foam, particularly methods for producing a pitch foam using a carbonaceous precursor material comprising hydrocarbons pressurized with a gaseous blowing agent.

### BACKGROUND

Carbon foams are porous forms of solid carbon that can be made from a variety of feed stocks. Potential feed stocks for the foaming precursor include raw coal, coal tar pitch, petroleum pitch, gasification tars, biomass, wood, polymers, and other hydrocarbon feed stocks. Generally, carbon foams are synthesized through a controlled coking process in which high pressures and high temperatures are used to both soften and devolatize the foaming precursor, at pressures of at least 100 psi and at temperatures of at least 400° C. This usually is accomplished in the presence of a non-reactive gas atmosphere in order to avoid oxidation. As the precursors soften and hydrocarbon vapors are liberated from the precursor, this results in the formation of bubbles in the bulk of the precursors. The high temperature also results in cross-linking of the carbon chains. This results in the fluid becoming more and more viscous until it formally becomes a solid. The carbon content rises through this process, as hydrogen leaves in the form of volatile hydrocarbon vapors. This process is known as carbonization. As a result, the foamed structure is locked in place and the material cannot become fluid again. This foam is called green foam and is relatively weak, particularly for the feed stocks that do not reach a true fluid state before carbonizing. After removing the foam samples from the molds, they are then calcined at about 1000° C. to about 1200° C. at ambient pressure in nitrogen or other inert gas. Calcining can be accomplished in laboratory furnaces or in special calcining furnaces. This completes the devolatization and cross-linking processes, resulting in substantially improved mechanical properties of the foam.

One significant drawback of the traditional foaming process described above is the high pressure needed during the foaming phase. The requirement for high pressure, generally provided by a high pressure autoclave, is not an issue for laboratory work, but would significantly increase the cost of producing the foam on an industrial scale. Furthermore, it limits the ultimate size of the foamed piece because of the massive hoop stresses that develop in a large autoclave.

Residence time is also an issue affecting the ability to produce carbon foam. Because the foam structure results in a low thermal conductivity, large volumes need to be heated very slowly in order to avoid large temperature differences in the bulk of the foam. Otherwise, differences in expansion might result in internal stresses.

The development of processes that require lower temperature and pressure are thus of great interest from the standpoint of process economics. Producing foam at atmospheric pressure may result in major cost savings over the high pressure approach because no autoclave is needed and the process can be converted to a continuous process from a batch process.

### SUMMARY

According to one embodiment, a method for producing a pitch foam comprises pressurizing a carbonaceous precursor material comprising hydrocarbons in a vessel with a gaseous blowing agent to form a pressurized solution of the carbonaceous precursor material and the gaseous blowing agent; exhausting the pressurized solution from the vessel such that the pressurized solution is substantially devolatized through the evaporation of the gaseous blowing agent and the hydrocarbons of the carbonaceous precursor material, forming a foam-like solution; and generating a pitch foam from the foam-like solution by directing the foam-like solution onto a surface of a container.

According to another embodiment, a method for producing a pitch foam comprises placing a carbonaceous precursor material comprising hydrocarbons in a vessel; flushing the vessel with a gaseous blowing agent to substantially remove air from the vessel; pressurizing the carbonaceous precursor material with the gaseous blowing agent in the vessel at a pressure from about 100 psi to about 3000 psi for a period of time sufficient to form a pressurized solution of the carbonaceous precursor material and the gaseous blowing agent; exhausting the pressurized solution from the vessel through a nozzle in communication with the vessel, wherein, as the pressurized solution is exhausted through the nozzle, the gaseous blowing agent and the hydrocarbons of the carbonaceous precursor material substantially evaporate from the pressurized solution, forming a foam-like solution; and generating a pitch foam from the foam-like solution by directing with the nozzle the foam-like solution onto a surface of a container.

According to yet another embodiment, a method for producing a carbon foam comprises pressurizing in a vessel a carbonaceous precursor material comprising hydrocarbons with a gaseous blowing agent to form a pressurized solution of the carbonaceous precursor material and the gaseous blowing agent; exhausting the pressurized solution from the vessel through a nozzle, wherein, as the pressurized solution is exhausted through the nozzle, the pressurized solution is substantially devolatized through the evaporation of the gaseous blowing agent and the hydrocarbons of the carbonaceous precursor material, forming a foam-like solution; generating a pitch foam from the foam-like solution by directing with the nozzle the foam-like solution onto a surface of a container; and heating in vacuum the pitch foam to a temperature sufficient to further evaporate the gaseous blowing agent and the hydrocarbons from the pitch foam to form a carbon foam.

### BRIEF DESCRIPTION OF THE DRAWINGS

It is believed that embodiments of the present invention will be better understood from the following description taken in conjunction with the accompanying drawings in which:

FIG. 1 is an illustration depicting an example of a system configured to perform a method for producing a pitch foam in accordance with one embodiment; and

FIG. 2 is an illustration of a scanning electron micrograph depicting an example of an open cell pitch foam in accordance with one embodiment.

### DETAILED DESCRIPTION

Embodiments relate generally to methods of producing a pitch foam where a carbonaceous precursor material is pressurized in a vessel with a gaseous blowing agent. The vessel may be any tank or container configured to hold a desired amount of the carbonaceous precursor material. In addition, the vessel may be configured to securely maintain a fluid pressure sufficient to pressurize the carbonaceous precursor material and to raise the temperature of the carbonaceous precursor material to one of many various temperatures, such as, but not limited to the softening temperature of the carbonaceous precursor material.

The carbonaceous precursor material generally comprises hydrocarbons, which, as described herein, may be removed, generally through evaporation, from the carbonaceous precursor material. The carbonaceous precursor material may comprise materials such as, but not limited to, coal tar pitch, coal tar, petroleum pitch, petroleum tar, gasification pitch, gasification tar, biomass pitch or tar, polymer materials, recycled polymers, tire rubber, recycled tire rubber, or a combination thereof. Generally, there is no need to pulverize or otherwise reduce the particle size of the carbonaceous precursor material prior to its introduction into the vessel for pressurization.

After the carbonaceous precursor material is introduced into the vessel, the vessel may be flushed with a gaseous blowing agent to remove fresh air from the vessel. More particularly, a sufficient volume of gaseous blowing agent may be used to displace and replace all, or substantially all, of the fresh air present in the vessel prior to the flushing. The gaseous blowing agent may comprise a gas such as, but not limited to, carbon dioxide, carbon monoxide, nitrogen, nitrogen oxides, air, inert gas, fluorocarbons, steam, water vapor, or a mixture thereof. Further, the gaseous blowing agent used to flush and pressurize the vessel generally is in a supercritical state. As used herein, “supercritical state” refers to when a gas is increased from its standard temperature and pressure, STP, to above its critical temperature and/or its critical pressure where the gas adopts properties between a gas and a liquid and can readily change density with minor changes in temperature or pressure.

When the vessel has been sufficiently flushed of fresh air, the gaseous blowing agent may be pressurized with the carbonaceous precursor material held within the vessel. In accordance with one embodiment, the method pressurizes the gaseous blowing agent ranging from about 100 psi to about 3000 psi. This pressurization of the carbonaceous precursor material and the gaseous blowing agent may form a pressurized solution of the carbonaceous precursor material and the gaseous blowing agent.

The pressurized solution may be heated within the vessel to above the melting point of the carbonaceous precursor material to facilitate dissolution of the gaseous blowing agent throughout the carbonaceous precursor material to facilitate a homogenous pressurized solution. In addition, or alternatively, a plasticizer may be added to the pressurized solution to reduce the viscosity of the carbonaceous precursor material to facilitate dissolution of the gaseous blowing agent throughout the carbonaceous precursor material to also facilitate a homogenous pressurized solution.

Further, in one embodiment, the method may comprise the adding of one or more additives into the pressurized solution of the carbonaceous precursor material and the gaseous blowing agent to form a modified pitch foam. In accordance with one embodiment, these additives may comprise materials such as, but not limited to, silicon, aluminum, titanium, refractory metals, oxides of silicon, oxides of aluminum, oxides of titanium, refractory metal oxides, other metals capable of forming metal carbide compounds, or combinations thereof. In another embodiment, the method may further include heating the modified pitch foam comprising the additives to form a metal carbide foam. In accordance with another embodiment, the one or more additives may comprise non-flammable ceramics, such as, but not limited to, aluminum oxide, silicon oxide, other metal oxides, metal bromides, glass fibers, fly ash, or combinations thereof. Such non-flammable ceramic additives may reduce the flammability of the modified pitch foam. In accordance with yet another embodiment, the one or more additives may include materials such as, but not limited to, carbon fibers, carbon nanotubes, glass fibers, aramid fibers, ceramic fibers, ceramic powders, or combinations thereof. Such additives may improve the mechanical properties of the modified pitch foam. In accordance with another embodiment, the method may further comprise blending one or more polymers with the carbonaceous precursor material to form a blended polymer foam comprising at least about 10% of the carbonaceous precursor material by weight, wherein the polymers may comprise polypropylene, polyester, polyurethane, rubbers, other polymeric materials, or combinations thereof.

In an embodiment, the method includes exhausting the pressurized solution from the vessel such that the pressurized solution is substantially devolatized through the evaporation of the gaseous blowing agent and the hydrocarbons of the carbonaceous precursor material. As used herein, “devolatized” refers to the removal, generally, but not necessarily, through evaporation, of one or more volatile substances, such as a gas or a solvent, from a substrate and/or solution. This devolatization of the pressurized solution may result in a formation of a foam-like solution as the pressurized solution is exhausted from the vessel. Generally, the exhausting of the pressurized solution is controlled through an opening (e.g., a valve) in communication with the vessel and may occur at very high rates, which can fluctuate depending on the size of the opening and the pressure inside of the vessel. More particularly, the operation of the valve may control the exhausting of the pressurized solution out from the vessel and through a nozzle in communication with the valve. The pressurized solution may be exhausted through this nozzle as a spray or an aerosol, or another manner sufficient to aid in the devolatization of the pressurized solution to form the foam-like solution. Thereafter, the method comprises forming a pitch foam from the foam-like solution by directing the foam-like solution onto a surface, such as, but not limited to, a container, wherein the container may be a mold. As shown in the illustration of FIG. 2, the pitch foam 22 generally comprises a multitude of open cell foam particles 34. These open cell foam particles may be created as the gas blowing agent and the hydrocarbons evaporate from pressurized solution during devolatization as the pressurized solution is exhausted from the vessel, through the nozzle.

The pitch foam may be thermally treated, in accordance with one embodiment, where the method further includes heating in air, carbon dioxide, or another oxidizing medium, the pitch foam to at least about 100° C. to cross-link the pitch foam and to further devolatize the pitch foam of the gaseous blowing agent and the hydrocarbons. More particularly, slow heating to above 100° C. at a rate of about 10° C./minute, or slower, in fresh air can be used to further devolatize and cross-link the pitch foam. This further devolatization and cross-linking increases the softening temperature of the pitch foam. In accordance with another embodiment, the method may comprise heating in vacuum the pitch foam to a temperature sufficient to further devolatize the pitch foam of the gaseous blowing agent and the hydrocarbons to form a carbon foam. More particularly, additional heating of the pitch foam above 1000° C. in vacuum can result in further devolatization of the pitch foam to form a porous carbon coke, which may also be referred to as a carbon foam. The carbon foam may then be cooled to ambient or standard temperature. In one embodiment, the carbon foam is slowly cooled at a rate of about 10° C./minute, or slower, so as to reduce and/or prevent thermal stress cracking of the carbon foam.

Other embodiments generally relate to methods of producing carbon foams from pitch foams. In accordance with one embodiment, a method for producing a carbon foam may comprise heating in vacuum the carbon foam to at least about 1000° C. to form carbon. In addition, in accordance with yet another embodiment, a method for producing a carbon foam may comprise heating in vacuum the carbon foam to at least about 2000° C. to graphitize the carbon foam.

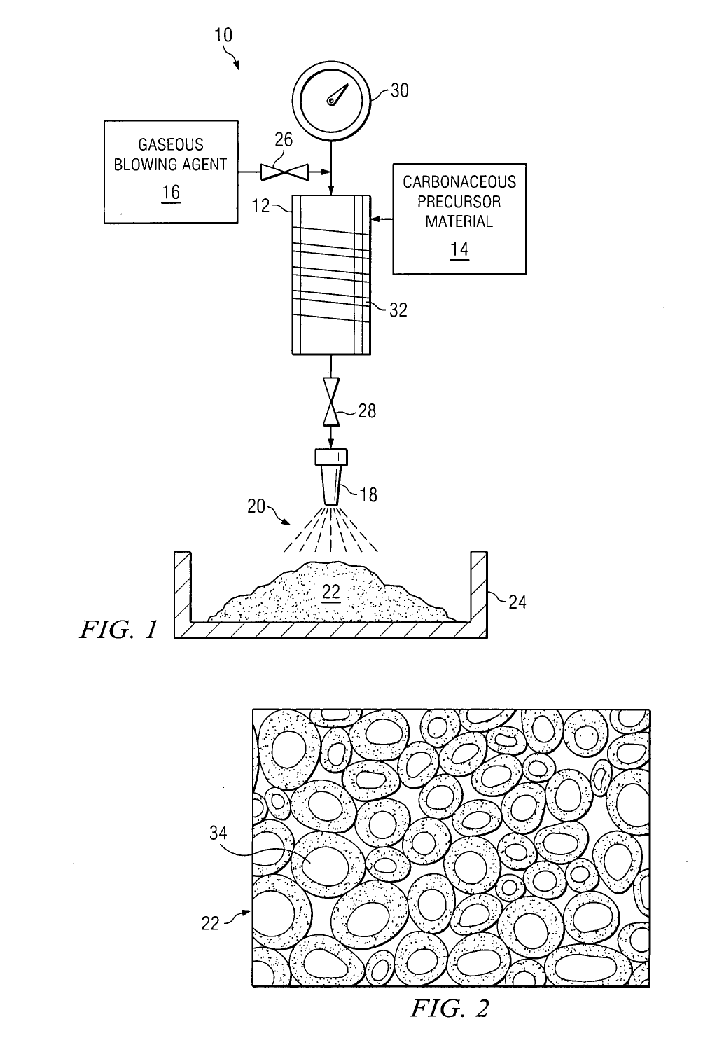

A system for producing a pitch foam and/or a carbon foam from an embodiment described herein is illustrated in FIG. 1. The system 10 generally comprises a vessel 12 to hold the carbonaceous precursor material 14 that is introduced thereto. A gaseous blowing agent 16 may be introduced into the vessel 12 to flush the vessel of fresh air. The introduction of the gaseous blowing agent 16 may be controlled through an adjustable opening and closing of a first valve 26 in communication with both the gaseous blowing agent 16 and the vessel 12. A pressure gauge 30 may monitor and display the pressure of the gaseous blowing agent 16 and the carbonaceous precursor material 14 inside the vessel 12. Heating tape 32, or other heat and/or cooling applying device, may be wrapped, or otherwise applied, around the outside of the vessel 12 to adjust the temperature of the carbonaceous precursor material 14, the gaseous blowing material 16, and/or the pressurized solution thereof.

After a substantially homogenous pressurized solution is formed between the carbonaceous precursor material 14 and the gaseous blowing agent 16, the pressurized solution may be exhausted from the vessel 12 through a nozzle 18. The rate of exhaustion of the pressurized solution may be controlled by an adjustable opening and closing of a second valve 28 in communication with both the vessel 12 and the nozzle 18. As the pressurized solution is exhausted through the nozzle 18, the pressurized solution is substantially devolatized with the substantial evaporation of the gaseous blowing agent 16 and the hydrocarbons of the carbonaceous precursor material 14 from the pressurized solution. This devolatization results in the formation of a foam-like solution 20 from the pressurized solution. This foam-like solution 20 may be directed by the nozzle 18 onto a surface of a container 24 where the foam-like solution rapidly substantially solidifies into a pitch foam 22. It is contemplated that this system 10 is an example of a system that may be used to perform an embodiment of a method described herein and that numerous variations can be made to this system 10 without affecting this performance.

The foregoing description of the various embodiments has been presented for the purposes of illustration and description. It is not intended to be exhaustive or to limit the inventions to the precise forms disclosed. Many alternatives, modifications, and variations will be apparent to those skilled in the art of the above teaching. Other embodiments will be apparent or relatively easily developed by those of ordinary skill in the art. Moreover, although multiple inventive aspects and features have been described, it should be noted that these aspects and features need not be utilized in combination in any particular embodiment. Accordingly, this invention is intended to embrace all alternatives, modifications, combinations, and variations.

It is noted that recitations herein of a component of the present invention being “configured” to embody a particular property, function in a particular manner, etc., are structural recitations, as opposed to recitations of intended use. More specifically, the references herein to the manner in which a component is “configured” denotes an existing physical condition of the component and, as such, is to be taken as a definite recitation of the structural characteristics of the component.

It is noted that terms like “generally,” “commonly,” and “typically” are not utilized herein to limit the scope of the claimed invention or to imply that certain features are critical, essential, or even important to the structure or function of the claimed invention. Rather, these terms are merely intended to highlight alternative or additional features that may or may not be utilized in a particular embodiment of the present invention.

What is claimed is:

1. A method for producing a pitch foam, the method comprising:
(a) pressurizing a carbonaceous precursor material comprising hydrocarbons in a vessel with a gaseous blowing agent to form a pressurized solution of the carbonaceous precursor material and the gaseous blowing agent;
(b) exhausting the pressurized solution from the vessel such that the pressurized solution is substantially devolatized through the evaporation of the gaseous blowing agent and the hydrocarbons of the carbonaceous precursor material, forming a foam-like solution; and
(c) generating a pitch foam from the foam-like solution by directing the foam-like solution onto a surface of a container.

2. The method of claim 1, wherein the carbonaceous precursor material comprises coal tar pitch, coal tar, petroleum pitch, petroleum tar, gasification pitch, gasification tar, biomass pitch or tar, polymer materials, recycled polymers, tire rubber, recycled tire rubber, or combinations thereof.

3. The method of claim 1, wherein the gaseous blowing agent comprises carbon dioxide, carbon monoxide, nitrogen, nitrogen oxides, air, inert gas, fluorocarbons, steam, water vapor, or mixtures thereof.

4. The method of claim 1, wherein the method pressurizes the carbonaceous precursor material with the gaseous blowing agent ranging from about 100 psi to about 3000 psi.

5. The method of claim 1, wherein the gaseous blowing agent is in a supercritical state.

6. The method of claim 1, wherein the pressurized solution of the carbonaceous precursor material and the gaseous blowing material is heated to above the melting point of the carbonaceous precursor material to facilitate dissolution of the gaseous blowing agent throughout the carbonaceous precursor material to facilitate a homogenous pressurized solution.

7. The method of claim 1, wherein a plasticizer is added to the pressurized solution to reduce the viscosity of the carbonaceous precursor material to facilitate dissolution of the gaseous blowing agent throughout the carbonaceous precursor material to facilitate a homogenous pressurized solution.

8. The method of claim 1, wherein one or more additives are added into the pressurized solution of the carbonaceous precursor material and the gaseous blowing agent to form a modified pitch foam.

9. The method of claim 8, wherein the one or more additives comprise silicon, aluminum, titanium, refractory metals, oxides of silicon, oxides of aluminum, oxides of titanium, refractory metal oxides, other metals capable of forming metal carbide compounds, or combinations thereof.

10. The method of claim 9, wherein the method further comprises heating the modified pitch foam comprising the additives to form a metal carbide foam.

11. The method of claim 8, wherein the one or more additives comprise non-flammable ceramics comprising aluminum oxide, silicon oxide, other metal oxides, metal bromides, glass fibers, fly ash, or combinations thereof.

12. The method of claim 8, wherein the one or more additives comprise carbon fibers, carbon nanotubes, glass fibers, aramid fibers, ceramic fibers, ceramic powders, or combinations thereof.

13. The method of claim 1, wherein the method further comprises blending one or more polymers with the carbonaceous precursor material to form a blended polymer foam comprising at least about 10% of the carbonaceous precursor material by weight, wherein the one or more polymers comprise polypropylene, polyester, polyurethane, rubbers, or combinations thereof.

14. The method of claim 1, wherein the method further comprises heating in vacuum the pitch foam to a temperature sufficient to further devolatize the pitch foam of the gaseous blowing agent and the hydrocarbons to form a carbon foam.

15. The method of claim 1, wherein the method further comprises heating in air, carbon dioxide, or another oxidizing medium, the pitch foam to at least about 100° C. to cross-link the pitch foam and to further devolatize the pitch foam of the gaseous blowing agent and the hydrocarbons.

16. The method of claim 1, wherein the pressurized solution is exhausted from the vessel through a nozzle as a spray or an aerosol.

17. A method for producing a pitch foam, the method comprising:
(a) placing a carbonaceous precursor material comprising hydrocarbons in a vessel;
(b) flushing the vessel with a gaseous blowing agent to substantially remove air from the vessel;
(c) pressurizing the carbonaceous precursor material with the gaseous blowing agent in the vessel at a pressure from about 100 psi to about 3000 psi for a period of time sufficient to form a pressurized solution of the carbonaceous precursor material and the gaseous blowing agent;
(d) exhausting the pressurized solution from the pressure vessel through a nozzle in communication with the vessel, wherein, as the solution is exhausted through the nozzle, the gaseous blowing agent and the hydrocarbons of the carbonaceous precursor material substantially evaporate from the solution, forming a foam-like solution; and
(e) generating a pitch foam from the foam-like solution by directing with the nozzle the foam-like solution onto a surface of a container.

18. A method for producing a carbon foam, the method comprising:
(a) pressurizing in a vessel a carbonaceous precursor material comprising hydrocarbons with a gaseous blowing agent to form a pressurized solution of the carbonaceous precursor material and the gaseous blowing agent;
(b) exhausting the pressurized solution from the vessel through a nozzle, wherein, as the pressurized solution is exhausted through the nozzle, the pressurized solution is substantially devolatized through the evaporation of the gaseous blowing agent and the hydrocarbons of the carbonaceous precursor material, forming a foam-like solution;
(c) generating a pitch foam from the foam-like solution by directing with the nozzle the foam-like solution onto a surface of a container; and
(d) heating in vacuum the pitch foam to a temperature sufficient to further evaporate the gaseous blowing agent and the hydrocarbons from the pitch foam to form a carbon foam.

19. The method of claim 18, wherein the method further comprises cooling the carbon foam at a rate not faster than about 110° C. per minute to reduce thermal stress cracking of the carbon foam during the cooling thereof.

20. The method of claim 18, wherein the method further comprises heating in vacuum the carbon foam to at least about 1000° C. to form carbon from the carbon foam.

21. The method of claim 18, wherein the method further comprises heating in vacuum the carbon foam to at least about 2000° C. to graphitize the carbon foam.
